(19) United States
(12) Patent Application Publication
(10) Pub. No.: US 2017/0188295 A1
(43) Pub. Date: Jun. 29, 2017

(54) METHODS AND SYSTEMS FOR DISTANCE-BASED SELECTION OF GATEWAY MOBILE RADIO

(71) Applicant: MOTOROLA SOLUTIONS, INC, CHICAGO, IL (US)

(72) Inventors: Pawel JURZAK, KRAKOW (PL); Leszek Pawel WOJCIK, KRAKOW (PL)

(21) Appl. No.: 15/320,338

(22) PCT Filed: Jul. 15, 2014
(86) PCT No.: PCT/PL2014/000080

§ 371 Date: Dec. 20, 2016

(51) Int. Cl. H04W 48/00; H04W 76/02; H04W 64/00

(52) U.S. Cl. CPC H04W 48/17; H04W 64/003; H04W 76/02; H04W 88/16

(57) ABSTRACT

Disclosed herein are methods and systems for distance-based selection of a gateway mobile radio. In an embodiment, a candidate mobile radio receives a gateway query associated with a requesting mobile radio, and obtains a distance between the candidate mobile radio and the requesting mobile radio. The candidate mobile radio selects a transmission time based at least in part on the obtained distance, and transmits a gateway advertisement at the selected transmission time.

### BACKGROUND OF THE INVENTION

Numerous individuals use mobile radios to communicate with other devices—either directly or via various radio access networks (RANs). Wireless communication is important in the context of public safety. A typical public-safety RAN is designed to have a given coverage area, and within the footprint of this coverage area, there are often locations such as inside buildings, tunnels, parking garages, etc., where coverage is poor and perhaps even effectively nonexistent. Moreover, the coverage footprint of the RAN is not infinite; it has edge zones where coverage is typically weaker; and at a certain distance from the network infrastructure (e.g., the nearest base station), the coverage simply ends. In the public-safety context, however, the exigencies of the job often require movement into such dead zones and/or outside of the coverage footprint (e.g., when pursuing a suspect, reaching an injured individual, and the like). As such, there is a need for methods and systems for distance-based selection of a gateway mobile radio.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example communication system, in accordance with various embodiments.

FIG. 2 depicts an example RAN via which one or more mobile radios can communicate, in accordance with various embodiments.

FIG. 3 depicts an example mobile radio, in accordance with various embodiments.

FIG. 4 is a flowchart of a process, in accordance with various embodiments.

FIG. 5 depicts an example scenario involving multiple mobile radios, as well as a coverage footprint of a base station, in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed herein are methods and systems for distance-based selection of a gateway mobile radio. In an embodiment, a candidate mobile radio receives a gateway query associated with a requesting mobile radio, and obtains a distance between the candidate mobile radio and the requesting mobile radio. The candidate mobile radio selects a transmission time based at least in part on the obtained distance, and transmits a gateway advertisement at the selected transmission time.

An embodiment takes the form of a candidate mobile radio that includes a communication interface, a processor, and data storage containing instructions executable by the processor for causing the candidate mobile radio to carry out at least the functions described in the preceding paragraph. Moreover, any of the variations and permutations described in the ensuing paragraphs and anywhere else in this disclosure can be implemented with respect to any embodiments, including with respect to any method embodiments and with respect to any system embodiments.

In at least one embodiment, obtaining the distance includes receiving the distance via an air interface.

In at least one embodiment, the candidate mobile radio receives a location of the requesting mobile radio via an air interface, and obtaining the distance includes deriving the distance from a location of the candidate mobile radio and the received location of the requesting mobile radio. In at least one such embodiment, the gateway query includes the location of the requesting mobile radio, and receiving the location of the requesting mobile radio via the air interface includes receiving the location of the requesting mobile radio in the gateway query. In at least one other such embodiment, the candidate mobile radio receives its location via the air interface. In yet another such embodiment, the candidate mobile radio determines its location.

In at least one embodiment, selecting the transmission time includes selecting a time slot, and transmitting the gateway advertisement includes transmitting the gateway advertisement during the selected time slot.

In at least one embodiment, selecting the transmission time includes selecting a delay period, and transmitting the gateway advertisement includes transmitting the gateway advertisement at an expiration of the delay period.

In at least one embodiment, selecting the transmission time includes selecting a clock time, and transmitting the gateway advertisement includes transmitting the gateway advertisement at the selected clock time.

In at least one embodiment, selecting the transmission time based at least in part on the obtained distance includes applying a distance-to-time scaling factor to the obtained distance. In at least such one embodiment, the gateway query includes the scaling factor, and the candidate mobile radio obtains the scaling factor from the gateway query.

In at least one embodiment, selecting the transmission time based at least in part on the obtained distance includes using the obtained distance to reference stored data that correlates distances to times.

In at least one embodiment, the candidate mobile radio establishes a gateway connection with the requesting mobile radio, and serves the requesting mobile radio via the established gateway connection. In at least one such embodiment, the candidate mobile radio presents a gateway-mode notification via a user interface.

In at least one embodiment, the candidate mobile radio verifies gateway capability prior to transmitting the gateway advertisement.

In at least one embodiment, the candidate mobile radio verifies gateway availability prior to transmitting the gateway advertisement.

In at least one embodiment, the candidate mobile radio conditions transmitting the gateway advertisement on having not detected any gateway advertisements from other candidate mobile radios.

In at least one embodiment, the candidate mobile radio identifies a collision condition with respect to the transmitted gateway advertisement, and responsively selects a follow-up transmission time, and transmits a follow-up gateway advertisement at the selected follow-up transmission time. In at least one such embodiment, identifying the collision condition includes receiving from the requesting mobile radio a follow-up gateway query that includes a follow-up distance-to-time scaling factor, and selecting the follow-up transmission time includes selecting the follow-up transmission time based at least in part on the follow-up scaling factor.

Before proceeding with this detailed description, it is noted that the entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—can only properly be read as being constructively preceded by a clause such as “In at least one embodiment, . . . .” And it is for reasons akin to brevity and clarity of presentation that this implied leading clause is not repeated ad nauseum in this detailed description.

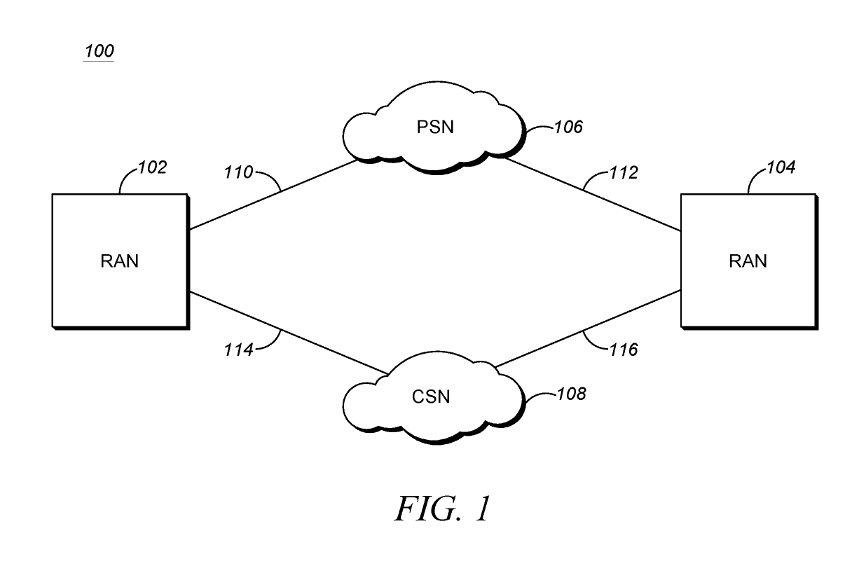

FIG. 1 depicts an example communication system, in accordance with various embodiments. As shown, communication system 100 includes respective RANs 102 and 104, a packet-switched network (PSN) 106, and a circuit-switched network (CSN) 108. Networks 102 and 104 are connected to PSN 106 by respective communication links 110 and 112, and to CSN 108 by respective communication links 114 and 116. Those having skill in the art will appreciate that additional and/or different entities may be present in communication system 100. For example, in accordance with some embodiments, the communication system 100 includes only a single RAN.

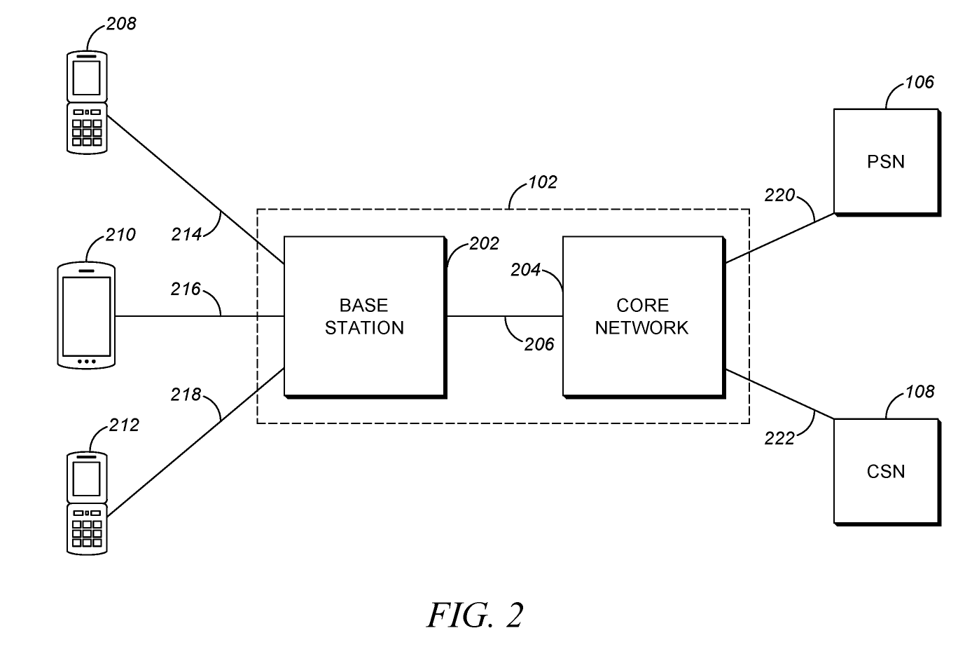

RAN 102 is discussed in further detail below with reference to FIG. 2, though in general, RANs 102 and 104 may be any networks equipped and configured by those of skill in the relevant art to function as described herein. One or both of RANs 102 and 104 may operate according to one or more communication protocols such as TErrestrial Trunked RAdio (TETRA), Association of Public-Safety Communications Officials-International (APCO) Project 25 (P25), LTE, Global System for Mobile Communications (GSM), CDMA2000, IEEE 902.11 (Wi-Fi), Bluetooth, ZigBee, and/or any other network protocol or standard, among many other possibilities known to those of skill in the relevant art.

In an embodiment, RAN 102 and/or RAN 104 is a public-safety network. In such an embodiment, the RAN is equipped, configured, and programmed to provide one or more public-safety agencies with wireless access to one or more networks, to facilitate provision of the communication and computing needs of those one or more public-safety agencies. The RAN may include or be connected to a dispatch center that itself may be communicatively connected with PSN 106 and/or CSN 108, for retrieving and transmitting any necessary public-safety-related data and/or communications.

PSN 106 could be the worldwide network typically referred to as the Internet, but could just as well be any other packet-switched network equipped and configured by those of skill in the relevant art to function as described herein. Entities resident on PSN 106 may be Internet Protocol (IP) entities and may be addressed using IP addresses, as examples. CSN 108 could be the circuit-switched communication network typically referred to as the Public Switched Telephone Network (PSTN), but could just as well be any other circuit-switched network arranged and configured by those of skill in the relevant art to function as described herein.

Any one or more of communication links 110-116 could include one or more communication devices, networks, connections, switches, bridges, routers, and the like. Any or all of communication links 110-116 could make use of wired and/or wireless forms of communication. Moreover, one or more communication links instead of and/or in addition to communication links 110-116 could be present. As one example, there could be one or more communication links between PSN 106 and CSN 108.

FIG. 2 depicts an example RAN via which one or more mobile radios can communicate, in accordance with various embodiments. As shown in FIG. 2, RAN 102 includes a base station 202 and a core network 204 that are communicatively connected via a communication link 206. Base station 202 is communicatively connected to mobile radios 208, 210, and 212 via respective air-interface links 214, 216, and 218, and core network 204 is communicatively connected to PSN 106 and CSN 108 via respective communication links 220 and 222. RAN 104 could take a form identical or similar to RAN 102.

Base station 202 may be any network-side entity that is suitably equipped and configured by those of skill in the relevant art to function as described herein, which in general is to provide wireless service to mobile radios (such as mobile radios 208, 210, and 212) over respective air-interface links (such as respective air-interface links 214, 216, and 218). Base station 202 could take the form of a TETRA base station, an APCO P25 base station, a WiFi access point, a GSM/CDMA2000 base transceiver station (BTS), and/or an LTE eNodeB, among numerous other examples known to those of skill in the relevant art. Moreover, while one base station 202 and three mobile radios 208, 210, and 212 are depicted in FIG. 2, this is by way of illustration and not by way of limitation, as any number of either could be present in a given implementation.

Air-interface links 214, 216, and 218 may each include a respective downlink and a respective uplink. Any one or more of the downlinks and/or uplinks may take the form of respective air-interface channels and could be modulated using Time Division Multiple Access (TDMA), Frequency Division Multiple Access (FDMA), and/or Quadrature Phase-Shift Keying (QPSK), among numerous other examples known to those of skill in the relevant art. In the time domain, a given channel may divided into frames, time slots, sub slots, etc. A respective downlink channel could (though need not) take the form of a shared channel, and could provide one or more of a circuit-mode-data service, a packet-mode-data service, and/or a Short Data Service (SDS) (i.e., a Short Message Service (SMS)), among numerous other examples known to those of skill in the relevant art. Communication over a given channel may be addressed to a single mobile radio using an identifier uniquely associated with that single mobile radio (e.g., an Individual Short Subscriber Identity (ISSI)) and/or to multiple mobile radios using an identifier that is associated with those multiple mobile radios as a group (e.g., a Group Short Subscriber Identity (GSSI)).

Core network 204 may include one or more network entities such as one or more mobility management entities (MMEs), one or more serving gateways (SGWs), one or more packet data network (PDN) gateways (PGWs), one or more evolved packet data gateways (ePDGs), one or more home subscriber servers (HSSs), one or more access network discovery and selection functions (ANDSFs), and/or one or more other entities deemed suitable for a given implementation by those of skill in the relevant art. Moreover, these entities may be configured and interconnected in a manner known to those of skill in the relevant art to provide wireless service to the mobile radios 208, 210, and 212 via base station 202, and to bridge such wireless service with various transport networks. These examples are provided for illustration and not by way of limitation; moreover, those of skill in the relevant art are aware of variations among different protocols and among different implementations of a given protocol, and of similarities across different protocols.

Communication links 206, 220, and 222 may take any suitable form, such as any of the forms described above in connection with links 110-116 of FIG. 1. Communication link 206 may function as what is known as a “backhaul” with respect to base station 202, as link 206 may enable core network 204 to bridge (i) communications conducted by base station 202 with mobile radios over respective air interfaces with (ii) communications via the rest of RAN 102 and beyond. One or more entities such as one or more network access servers (NAS) and/or Voice over IP (VoIP) gateways may reside on any one or more of the communication links to bridge RAN 102 to one or more other networks.

Mobile radios 208, 210, and 212 may take the form of respective mobile phones, smart phones, tablet computers, notebook computers, desktop computers, and/or any other types of wireless-communication devices suitably equipped and configured by those of skill in the relevant art to function as described herein.

As known to those of skill in the relevant art, RAN 102 may include additional and/or different entities deemed suitable to a given implementation by those of skill in the relevant art. Moreover, these entities may be configured and interconnected in any manner known to those of skill in the relevant art to provide wireless service to mobile radios via base stations, and to bridge such wireless service with transport networks such as PSN 106 and CSN 108. In general, other configurations are possible, as those described herein are provided by way of example and not limitation.

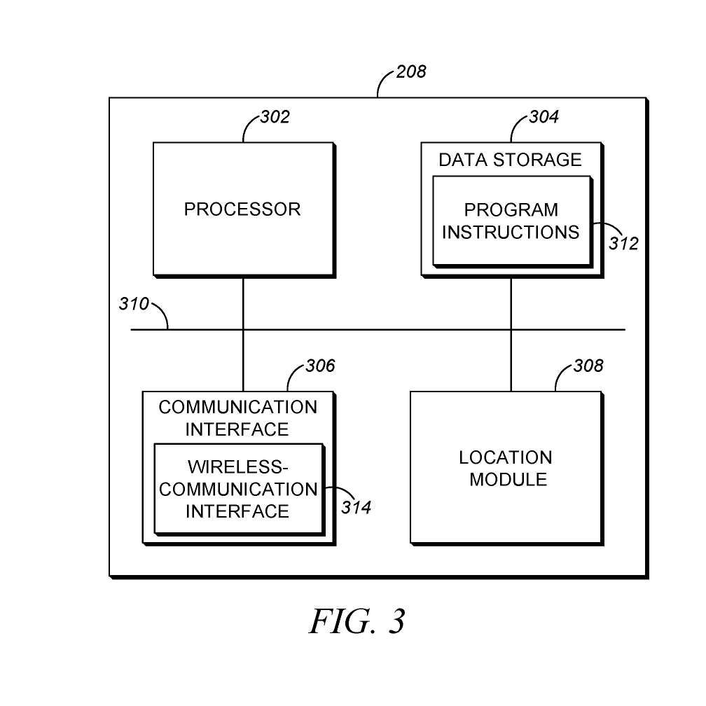

FIG. 3 depicts an example mobile radio, in accordance with various embodiments. As illustrated, mobile radio 208 includes a processor 302, data storage 304, a communication interface 306, and a location module 308, all of which are communicatively connected by a system bus 310 (or other suitable communication network, connection, and/or the like). It will be understood by those of skill in the art that different and/or additional components may be present, and that the mobile radio may take other forms as well.

Processor 302 may include one or more processors of any type deemed suitable by those of skill in the relevant art, some examples including a general-purpose microprocessor, a dedicated digital signal processor (DSP), and a graphics processor.

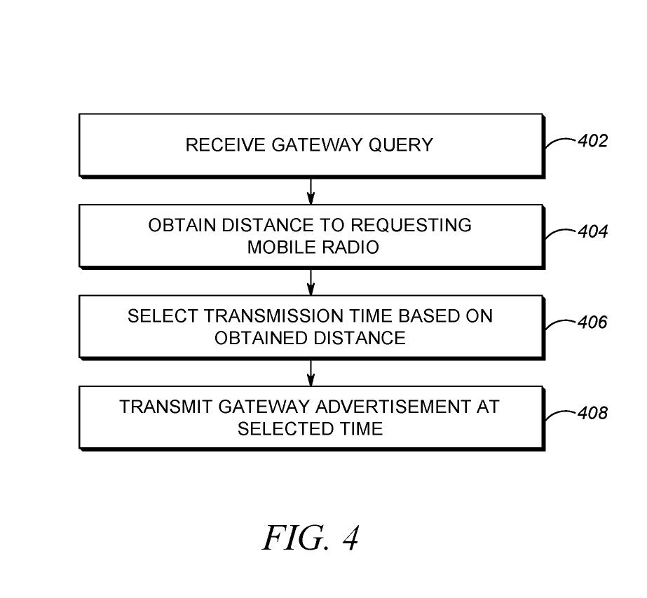

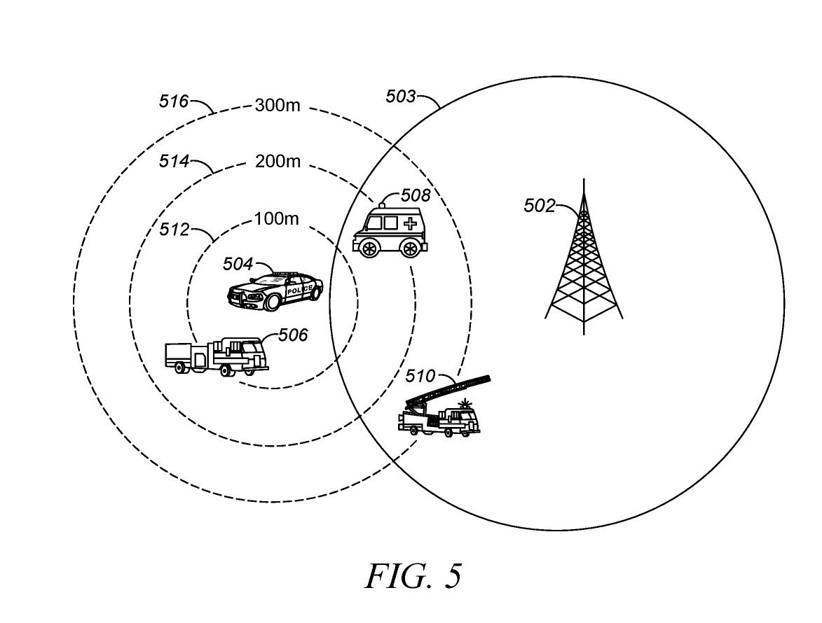

Data storage 304 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. In the embodiment that is depicted in FIG. 3, data storage 304 contains program instructions 312 executable by processor 302 for carrying out various combinations of the various functions described herein, including but not limited to those mobile-radio functions described with respect to FIGS. 4-5. The data storage could include additional data as well, including (for example) data files, data-file segments, network routing data, and/or any other types of data deemed suitable by those of skill in the relevant art for carrying out the functions described herein.

Communication interface 306 is depicted as including a wireless-communication interface 314, which in turn could include components such as one or more antennae, one or more transmitters and/or receivers designed and configured for one or more types of wireless communication, and/or any other components deemed suitable by those of skill in the relevant art. In addition to wireless-communication interface 314, communication interface 306 could further include additional communication-interface technology such as one or more wired (e.g., Ethernet) communication interfaces for facilitating communication with various network entities.

Location module 308 could be any combination of hardware and/or software that is capable of performing the location-determination functions described herein. In an embodiment, mobile radio 208 includes a Global Positioning System (GPS) receiver, and location module 308 is configured to derive a location based on messages transmitted by a GPS satellite and obtained via the GPS receiver. In another embodiment, location module 308 is configured to triangulate a position based on radio signals received from one or more base stations via communication interface 306. In other embodiments, processor 302 may perform the location-determination functions, perhaps with the aid of wireless-communication interface 314 and perhaps as a result of executing location-determination instructions stored in program instructions 312. Those of skill in the art will appreciate that other means of determining a location are possible as well.

FIG. 4 is a flowchart of a process, in accordance with various embodiments. As shown, process 400 begins at step 402 with a candidate mobile radio receiving a gateway query associated with a requesting mobile radio. The query could include, for example, a distance between the candidate mobile radio and the requesting mobile radio, a location of the requesting mobile radio, a location of the candidate mobile radio, and/or a distance-to-time scaling factor, among numerous other possibilities. Receiving the gateway query could involve the candidate mobile radio receiving the gateway query from the requesting mobile and/or from a base station (among others). Those of skill in the art will appreciate that receiving the gateway query could take other forms as well.

At step 404, the candidate mobile radio obtains a distance between the candidate mobile radio and the requesting mobile radio. In an embodiment, obtaining the distance involves the candidate mobile radio receiving the distance via an air interface. The candidate mobile radio could receive the distance (i.e., a distance value) via the air interface using its communication interface 306, and perhaps in particular using its wireless-communication interface 314, among other possibilities, and the distance could be received from the requesting mobile radio, another mobile radio, and/or a base station, as examples. The received gateway query could include the distance; as such, receiving the distance via the air interface could involve the receiving the distance in the gateway query, though in general, receiving the distance via the air interface could take other forms as well.

In an embodiment, the candidate mobile radio obtains the distance by deriving the distance from respective locations of the candidate mobile radio (i.e., itself) and the requesting mobile radio according to methods known to those of skill in the art. Either or both locations may be determined by the candidate mobile radio and/or may be received by the candidate mobile radio via an air interface, among other possibilities known to those of skill in the relevant art. In an example, the candidate mobile radio determines its location using location module 308. In some instances, the received gateway query includes one or both of those locations; i.e., the candidate mobile radio may receive one or both of those locations as data included in the received gateway query. Those of skill in the art will appreciate that other means of obtaining the distance between the candidate mobile radio and the requesting mobile radio are possible as well.

At step 406, the candidate mobile radio selects a transmission time based at least in part on the obtained distance, and at step 408, transmits a gateway advertisement at the selected transmission time.

Selecting the transmission time based on the obtained distance may involve applying a distance-to-time scaling factor to the obtained distance. In an example, the gateway query includes a scaling factor of 1 millisecond (ms) per meter (m). In this example, then, the candidate mobile radio obtains the scaling factor from the gateway query, and applies the 1 ms/m scaling factor to the obtained distance, which in this example is 250 m. The candidate mobile radio obtains a result of 250 ms, and selects a transmission time based on the 250-ms result.

Additionally or alternatively, selecting the transmission time based on the obtained distance may involve using the obtained distance to reference stored data that correlates distances to times. In an example, the obtained distance is 250 m and the stored correlation data includes the data shown in Table 1 below:

TABLE 1

| Distance Value | Time Value |
|---|---|
| 50 m | 73 ms |
| 100 m | 157 ms |
| 150 m | 245 ms |
| 200 m | 337 ms |
| 250 m | 430 ms |
| 300 m | 526 ms |

In this example, the candidate mobile radio references the correlation data for a distance value that matches or approximates the obtained distance. As shown, the correlation data in Table 1 includes a distance value (250 m) that matches the obtained distance. The candidate mobile radio accordingly obtains the time value (430 ms) that—in this example—is associated with that distance value.

Moreover, the selected transmission time itself may take one or more forms, and accordingly the steps of selecting the transmission time (i.e., step 406) and transmitting a gateway advertisement at the selected transmission time (i.e., step 408) may take one or more forms as well. A few possibilities are discussed below.

In at least one embodiment, selecting the transmission time involves selecting a delay period, and transmitting the gateway advertisement at the selected transmission time involves transmitting the advertisement at an expiration of the delay period. In an example, the candidate mobile radio selects a delay period of 250 ms by applying a scaling factor of 1 ms/m to an obtained distance of 250 m. The candidate mobile radio begins a 250 ms timer and transmits the gateway advertisement at the expiration of the timer. The candidate mobile radio may offset the timer based on an amount of time between when the gateway query was received and when the timer is started. For example, if 14 ms elapsed between the gateway query being received and the timer being started (the delay being attributable to, e.g., obtaining the distance and selecting the transmission time), the candidate mobile radio may begin a timer of 236 ms (i.e., 250 ms less 14 ms). And certainly other examples could be listed.

In at least one embodiment, selecting the transmission time involves selecting a clock time, and transmitting the gateway advertisement at the selected transmission time involves transmitting the advertisement at the selected clock time. In an example, the gateway query specifies a reference time as a Unix Epoch Time (which is the number of ms that have elapsed since Thursday, 1 Jan. 1970 at 00:00:00 UTC). The candidate mobile radio selects a transmission time that is 250 ms after the reference time (the 250 ms having been obtained, e.g., by applying a scaling factor of 1 ms/m to an obtained distance of 250 m), and transmits the advertisement at the selected transmission time.

In at least one embodiment, selecting the transmission time involves selecting a time slot, and transmitting the gateway advertisement at the selected transmission time involves transmitting the advertisement during the selected time slot. In an example, the candidate mobile radio receives the gateway query via a TDMA air interface that is divided into a plurality of time slots. At the expiration of the delay period or at the selected clock time, as examples, the candidate mobile radio selects the next time slot and transmits the advertisement during that selected time slot. Those of skill in the relevant art will appreciate that selecting the transmission time may involve a combination of one or more of the described embodiments, and may take other forms as well.

In an embodiment, prior to transmitting the gateway advertisement, the candidate mobile radio verifies gateway capability (i.e., that it is a device that, as a general matter, is capable of functioning as a gateway in at least the manner requested by the requesting mobile radio). As one possibility, verifying gateway capability may involve verifying that the candidate mobile radio contains hardware and/or software for functioning as a gateway. For example, some implementations may require that the candidate mobile radio include two transceivers—one for communicating with the requesting mobile radio, and another for communicating with a base station or other network entity. As another possibility, verifying gateway capability may involve verifying that the candidate mobile radio is not a portable (e.g., handheld) mobile radio, perhaps so that limited battery power is not expended for relaying communication with the requesting mobile radio, and/or so that the mobile radio that serves as a gateway for another mobile radio will not run out of power, and therefore leave the other mobile radio without a functioning gateway. As a possibility, verifying gateway capability may involve verifying that a gateway feature is enabled (e.g., verifying that a network subscription permits that candidate mobile radio to function as a gateway). Those of skill in the art will appreciate that verifying gateway capability may involve a combination of these and/or other approaches.

In an embodiment, prior to transmitting the gateway advertisement, the candidate mobile radio verifies gateway availability (i.e., that it is a device that, assuming gateway capability, is available at that time to actually serve as a gateway for another mobile radio). Verifying gateway availability may involve, for example, verifying that a power source is of a given type (e.g., AC power, vehicle battery, portable generator, etc.) and/or verifying that an available amount of power (e.g., a handheld-radio battery level) is above a given threshold. As another possibility, verifying gateway availability may involve the candidate mobile radio verifying its connectivity to one or more base stations and/or one or more other network entities—e.g., by verifying that the candidate mobile radio is within a coverage footprint of a given RAN—and/or verifying the availability of a network resource (such as an air-interface channel, for example). Those of skill in the art will appreciate that verifying gateway availability may involve a combination of these and/or other approaches.

In at least one embodiment, the candidate mobile radio conditions the transmitting of the gateway advertisement on having not detected any gateway advertisements from other candidate mobile radios. For example, upon selecting a transmission time, the candidate mobile radio may begin monitoring an air interface for gateway advertisements from other candidate mobile radios. If, at the selected transmission time, the candidate mobile radio has not yet detected (via the monitored air interface) any gateway advertisements from other candidate mobile radios, then the candidate mobile radio may transmit the advertisement (and may also cease monitoring the air interface for advertisements from other mobile radios). As will be appreciated by those of skill in the relevant art, conditioning transmission of the gateway advertisement may take other forms as well.

In an embodiment, the candidate mobile radio identifies a collision condition with respect to the transmitted gateway condition. In response to identifying the collision condition, the candidate mobile radio (i) selects a follow-up transmission time and (ii) transmits a follow-up gateway advertisement at the selected follow-up transmission time. Identifying the collision condition could involve receiving a follow-up gateway query from the requesting mobile radio. The follow-up gateway query could include an indication of the collision condition, and/or could include a follow-up distance-to-time scaling factor, as examples. Additionally or alternatively, identifying the collision condition could involve monitoring an air interface for the collision condition—for example, by detecting that a gateway advertisement from another mobile radio was transmitted at substantially the same time (e.g., a same time slot) as the time at which the candidate mobile radio transmitted an advertisement. And certainly other example implementations could be listed as well.

Selecting the follow-up transmission time could involve selecting the follow-up transmission time based, at least in part, on a follow-up scaling factor. In an example, the candidate mobile radio initially selected a transmission time by applying an initial distance-to-time scaling factor to the obtained distance. The initial scaling factor may have been obtained from an initial gateway query received by the candidate mobile radio, and/or may have been selected by the candidate mobile radio (by, e.g., using a default value). Upon identifying a collision condition, the candidate mobile radio may select a follow-up transmission time based on, e.g., a follow-up scaling factor, which the candidate mobile radio may obtain from a follow-up gateway query received by the candidate mobile radio; in at least one embodiment, that follow-up scaling factor was selected by the requesting mobile radio in response to having identified a collision condition). Additionally or alternatively, a follow-up scaling factor may be selected based on a default follow-up scaling factor identified by the candidate mobile radio. In an example, the follow-up scaling factor is greater than the initial scaling factor (though the follow-up scaling factor could instead be less than the initial scaling factor). The candidate mobile radio may then transmit a follow-up gateway advertisement at the selected follow-up transmission time. Those of skill in the art will appreciate that identifying the collision condition and/or selecting the follow-up transmission time may take other forms as well.

In an embodiment, the candidate mobile radio (i) establishes a gateway connection with the requesting mobile radio and (ii) serves the requesting mobile radio via the established gateway connection. The candidate mobile radio may establish the gateway connection in response to receiving a gateway-connection invitation, which may have been transmitted by the requesting mobile radio in response to receiving a gateway advertisement from the candidate mobile radio, among other possibilities. In an embodiment, the candidate mobile radio also presents a gateway-mode notification via a user interface, indicating that the candidate mobile radio is serving as a gateway mobile radio. The notification could indicate, for example, an identity of the requesting mobile radio and/or a signal strength (RSSI/SINR/SQI) of the established gateway connection. Other variations are possible, as will be known to those of skill in the art.

An example operation is described with reference to FIG. 5, which depicts an example scenario involving multiple mobile radios, as well as a coverage footprint of a base station, in accordance with various embodiments. As shown, a base station 502 provides a coverage footprint 503. In proximity to a requesting mobile radio 504 are respective candidate mobile radios 506, 508, and 510. During a time period t=0 ms to t=300 ms, candidate mobile radio 506 is outside of coverage footprint 503, and candidate mobile radios 508 and 510 are within the coverage footprint 503. Distance markers 512, 514, and 516 indicate that candidate mobile radios 506, 508, and 510 are at respective distances of 100 m, 200 m, and 300 m from requesting mobile radio 504.

At time t=0 ms, requesting mobile radio 504 broadcasts, and each of candidate mobile radios 506, 508 and 510 receive, a gateway query associated with requesting mobile radio 504. In this example, the gateway query includes both a location of requesting mobile radio 504 and a distance-to-time scaling factor. Each candidate mobile radio determines its respective location (using GPS, for example) and receives the location of requesting mobile radio 504 that is in the gateway query. Each candidate mobile radio then derives, from its respective determined location and the received location of requesting mobile radio 504, a respective distance between the respective candidate mobile radio and requesting mobile radio 504. Each of the candidate mobile radios 506-510 obtains the scaling factor (1 ms/m in this example) from the gateway query, and applies the scaling factor to the respective derived distances to obtain respective delay periods of 100 ms (candidate mobile radio 506), 200 ms (candidate mobile radio 508), and 300 ms (candidate mobile radio 510). Each of the candidate mobile radios 506-510 starts a respective timer according to its respective delay period.

In this example, during their respective delay periods, candidate mobile radios 506, 508 and 510 evaluate their respective gateway capabilities and gateway availabilities, and additionally monitor their respective air interfaces for gateway advertisements from other candidate mobile radios. In at least one embodiment, a respective candidate mobile radio conditions transmission of a gateway advertisement on not having detected transmissions of any gateway advertisements by any other candidate mobile radios. In at least one embodiment, upon determining to not transmit a gateway advertisement, a respective candidate mobile radio may also cease monitoring its respective air interface for gateway advertisements, and may stop its delay-period timer. Moreover, respective gateway availabilities of one or more candidate mobile radios may change during their respective delay periods (if, e.g., one or more candidate mobile radios move out of network coverage during their delay period); accordingly, candidate mobile radios may (though needn't necessarily) evaluate their respective availabilities at multiple times during their delay period.

Upon expiration of their respective delay periods, candidate mobile radios 506, 508 and 510 determine whether to transmit respective gateway advertisements. In this example, a respective candidate mobile radio determines to transmit a gateway response if (i) it did not detect any gateway advertisements from other candidate mobile radios during its delay period and (ii) its most recent evaluation (during its respective delay period) of its gateway capability and availability verifies that it can and is available to act as a gateway.

Accordingly, in this particular example, at t=100 ms, candidate mobile radio 506 determines not to transmit a gateway advertisement because the most-recent evaluation of its gateway availability indicates that it is not within coverage footprint 503 of base station 502. At t=200 ms, candidate mobile radio 508 transmits a gateway advertisement responsive to determining that (i) it did not detect any gateway advertisement from other candidate mobile radios during its respective delay period and (ii) its most-recent evaluation of its gateway capability and availability verifies that it can and is available to act as a gateway. Moreover, and also at t=200 ms, candidate mobile radio 510 detects the gateway advertisement transmitted by candidate mobile radio 508, and responsively determines not to transmit a gateway advertisement. In an embodiment, candidate mobile radio 510 also stops monitoring the air interface for gateway advertisements, and stops its delay-period timer. And certainly many other example scenarios and sequences could be described here, as will be appreciated by those having skill in the relevant art.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
a candidate mobile radio receiving a gateway query associated with a requesting mobile radio;
the candidate mobile radio obtaining a distance between the candidate mobile radio and the requesting mobile radio;
the candidate mobile radio selecting a transmission time based at least in part on the obtained distance; and
the candidate mobile radio transmitting a gateway advertisement at the selected transmission time.

2. The method of claim 1, wherein obtaining the distance comprises receiving the distance via an air interface.

3. The method of claim 1, further comprising the candidate mobile radio receiving a location of the requesting mobile radio via an air interface, wherein obtaining the distance comprises deriving the distance from a location of the candidate mobile radio and the received location of the requesting mobile radio.

4. The method of claim 3, wherein the gateway query comprises the location of the requesting mobile radio, wherein receiving the location of the requesting mobile radio via the air interface comprises receiving the location of the requesting mobile radio in the gateway query.

5. The method of claim 3, further comprising the candidate mobile radio receiving the location of the candidate mobile radio via the air interface.

6. The method of claim 3, further comprising the candidate mobile radio determining the location of the candidate mobile radio.

7. The method of claim 1, wherein selecting the transmission time comprises selecting a time slot, wherein transmitting the gateway advertisement comprises transmitting the gateway advertisement during the selected time slot.

8. The method of claim 1, wherein selecting the transmission time comprises selecting a delay period, wherein transmitting the gateway advertisement comprises transmitting the gateway advertisement at an expiration of the delay period.

9. The method of claim 1, wherein selecting the transmission time comprises selecting a clock time, wherein transmitting the gateway advertisement comprises transmitting the gateway advertisement at the selected clock time.

10. The method of claim 1, wherein selecting the transmission time based at least in part on the obtained distance comprises applying a distance-to-time scaling factor to the obtained distance.

11. The method of claim 10, wherein the gateway query comprises the scaling factor, the method further comprising obtaining the scaling factor from the gateway query.

12. The method of claim 1, wherein selecting the transmission time based at least in part on the obtained distance comprises using the obtained distance to reference stored data that correlates distances to times.

13. The method of claim 1, further comprising:
the candidate mobile radio establishing a gateway connection with the requesting mobile radio; and
the candidate mobile radio serving the requesting mobile radio via the established gateway connection.

14. The method of claim 13, further comprising the candidate mobile radio presenting a gateway-mode notification via a user interface.

15. The method of claim 1, further comprising the candidate mobile radio verifying gateway capability prior to transmitting the gateway advertisement.

16. The method of claim 1, further comprising the candidate mobile radio verifying gateway availability prior to transmitting the gateway advertisement.

17. The method of claim 1, wherein the candidate mobile radio conditions transmitting the gateway advertisement on having not detected any gateway advertisements from other candidate mobile radios.

18. The method of claim 1, further comprising the candidate mobile radio identifying a collision condition with respect to the transmitted gateway advertisement, and responsively:
selecting a follow-up transmission time; and
transmitting a follow-up gateway advertisement at the selected follow-up transmission time.

19. The method of claim 18, wherein:
identifying the collision condition comprises receiving a follow-up gateway query from the requesting mobile radio, the follow-up gateway query comprising a follow-up distance-to-time scaling factor; and
selecting the follow-up transmission time comprises selecting the follow-up transmission time based at least in part on the follow-up scaling factor.

20. A candidate mobile radio comprising:
a communication interface;
a processor; and
data storage containing instructions executable by the processor for causing the candidate mobile radio to carry out a set of functions, the set of functions including:
receiving a gateway query associated with a requesting mobile radio;
obtaining a distance between the candidate mobile radio and the requesting mobile radio;
selecting a transmission time based at least in part on the obtained distance; and
transmitting a gateway advertisement at the selected transmission time.
